(19) United States
(12) Patent Application Publication
(10) Pub. No.: US 2024/0421629 A1
(43) Pub. Date: Dec. 19, 2024

(54) CONTROL CIRCUIT, METHOD, AND APPARATUS FOR BACKUP BATTERY UNIT, AND STORAGE SYSTEM

(71) Applicant: SUZHOU METABRAIN INTELLIGENT TECHNOLOGY CO., LTD., Suzhou, Jiangsu (CN)

(72) Inventors: Yaoyu HUA, Suzhou, Jiangsu (CN); Xuetao CUI, Suzhou, Jiangsu (CN); Ruijie WANG, Suzhou, Jiangsu (CN); Lupan WANG, Suzhou, Jiangsu (CN)

(21) Appl. No.: 18/703,121

(22) PCT Filed: Aug. 19, 2022
(86) PCT No.: PCT/CN2022/113523

§ 371 Date: Apr. 19, 2024

(30) Foreign Application Priority Data
Mar. 31, 2022 (CN) 202210334030.0

(51) Int. Cl. H02J 9/06; H02J 7/00

(52) U.S. Cl. CPC H02J 9/06; H02J 7/00045; H02J 7/0045; H02J 2207/20

(57) ABSTRACT

Disclosed are a control circuit, method, and apparatus for a backup battery unit (BBU), and a storage system, being applied to the technical field of storage. The control circuit includes a BBU charge circuit; the BBU charge circuit includes an improved H-bridge charge unit; and the improved H-bridge charge unit includes a first switch transistor, a second switch transistor, a third switch transistor, a diode, and an inductor.

This application claims priority to Chinese Patent Application No. 202210334030.0, filed on Mar. 31, 2022 in China National Intellectual Property Administration and entitled “Control Circuit, Method, and Apparatus for Backup Battery Unit, and Storage System”, the entire contents of which are hereby incorporated by reference.

### FIELD

The present application relates to the technical field of storage, in particular to a control circuit, method, and apparatus for a backup battery unit (BBU), and a storage system.

### BACKGROUND

In the era of big data, higher requirements are put forward for the reliability of storage arrays, especially for the power supply stability of storage systems. At present, a packed BBU is usually arranged to supply power to a power supply unit (PSU) of a storage system when an external power source is powered off, thereby avoiding a data loss caused by the power off of the external power source and improving the power supply reliability of the storage system.

The inventors have realized that it is an urgent problem to improve the reliability of the charge and discharge of the BBU, thereby ensuring that the BBU might provide stable and reliable power supply.

### SUMMARY

According to various embodiments disclosed in the present application, a control circuit, method, and apparatus for a BBU, and a storage system are provided.

The control circuit for the BBU includes: a BBU charge unit; where the BBU charge unit includes: an improved H-bridge charge unit; the improved H-bridge charge unit includes a first switch transistor, a second switch transistor, a third switch transistor, a diode, and an inductor; a first end of the first switch transistor is configured to be connected to an input end of a charge power source, a second end of the first switch transistor is connected to a first end of the inductor and a cathode of the diode; a second end of the inductor is connected to a first end of the second switch transistor and a second end of the third switch transistor; a second end of the second switch transistor is configured to be connected to an input end of a BBU pack; an anode of the diode and a first end of the third switch transistor are grounded; control ends of the first switch transistor, the second switch transistor and the third switch transistor are connected to a BBU control unit for switching charge modes of the BBU based on the control of the BBU control unit; and the charge modes include a pre-charge mode, a constant-current charge mode and a constant-voltage charge mode.

The control method for the BBU is applied to the control circuit for the BBU as described above, and includes: acquiring a system control signal; and controlling charge modes of a BBU charge circuit in the control circuit for the BBU according to circuit sampling information of the control circuit for the BBU in response to the system control signal being a BBU charge control signal; where the charge modes include a pre-charge mode, a constant-current charge mode and a constant-voltage charge mode.

The control apparatus for the BBU is applied to the control circuit for the BBU as described above, and includes: a signal acquisition module, configured to acquire a system control signal; and a circuit control module, configured to control charge modes of a BBU charge circuit in the control circuit for the BBU according to circuit sampling information of the control circuit for the BBU in response to the system control signal being a BBU charge control signal; where the charge modes include a pre-charge mode, a constant-current charge mode and a constant-voltage charge mode.

The storage system includes: a memory, a processor and the control circuit for the BBU as described above; where the memory is configured to store computer-readable instructions; and the processor is configured to implement the steps of the control method for the BBU as described above when the computer-readable instructions are executed.

The details of one or more embodiments of the present application are set forth in the accompanying drawings and the description below. Other features and advantages of the present application will be apparent from the description, accompanying drawings and claims.

### BRIEF DESCRIPTION OF THE DRAWINGS

In order to explain the embodiments of the present application or the technical solutions in the prior art more clearly, a brief introduction will be made to the accompanying drawings required in the embodiments or the description of the prior art. Apparently, the accompanying drawings in the following description are merely embodiments of the present application, and for those skilled in the art, other accompanying drawings might also be obtained according to the accompanying drawings provided without creative labor.

FIG. 1 is a circuit schematic diagram of a BBU charge circuit in a control circuit for a BBU according to one or more embodiments;

FIG. 2 is a circuit schematic diagram of a BBU discharge circuit in a control circuit for a BBU according to one or more embodiments;

FIG. 3 is a circuit schematic diagram of a pack-side hot-plug protection circuit in a control circuit for a BBU according to one or more embodiments;

FIG. 4 is a circuit schematic diagram of a system-side hot-plug protection circuit in a control circuit for a BBU according to one or more embodiments;

FIG. 5 is a flowchart illustrating a control method for a BBU according to one or more embodiments;

FIG. 6 is a flowchart illustrating a control method for a BBU according to one or more embodiments;

FIG. 7 is a structural block diagram of a control apparatus for a BBU according to one or more embodiments; and

FIG. 8 is a structural block diagram of a storage system according to one or more embodiments.

### DETAILED DESCRIPTION

In order that the objects, technical solutions and advantages of the embodiments of the present application will become more apparent, the technical solutions in the embodiments of the present application will now be described clearly and completely with reference to the accompanying drawings in the embodiments of the present application. It is obvious that the described embodiments are some, but not all, embodiments of the present application. All other embodiments obtained by those of ordinary skill in the art based on the embodiments in the present application without creative labor fall within the scope of protection of the present application.

Reference is now made to FIG. 1, which is a circuit schematic diagram of a BBU charge circuit in a control circuit for a BBU according to one or more embodiments. The control circuit for the BBU may include: a BBU charge unit; where the BBU charge unit includes: an improved H-bridge charge unit 10; the improved H-bridge charge unit 10 includes a first switch transistor Q5, a second switch transistor Q4, a third switch transistor Q3, a diode D1 and an inductor L1; a first end of the first switch transistor Q5 is configured to be connected to an input end of a charge power source, a second end of the first switch transistor Q5 is connected to a first end of the inductor L1 and a cathode of the diode D1; a second end of the inductor L1 is connected to a first end of the second switch transistor Q4 and a second end of the third switch transistor Q3; a second end of the second switch transistor Q4 is configured to be connected to an input end of a BBU pack; an anode of the diode D1 and a first end of the third switch transistor Q3 are grounded; control ends of the first switch transistor Q5, the second switch transistor Q4 and the third switch transistor Q3 are connected to a BBU control unit for switching charge modes of the BBU based on the control of the BBU control unit; and the charge modes include a pre-charge mode, a constant-current charge mode and a constant-voltage charge mode.

It might be understood that the BBU pack in this embodiment may be a battery pack of packed BBU. The BBU charge circuit in the control circuit for the BBU in this embodiment may be a circuit configured to charge the BBU pack with electric energy outputted from a charge power source (such as a constant-voltage source). In this embodiment, by arranging the improved H-bridge charge unit 10 in the BBU charge circuit, the BBU charge circuit might charge the BBU pack in three charge modes, namely, the pre-charge mode, the constant-current charge mode and the constant-voltage charge mode based on the control of the BBU control unit, thereby ensuring the charge efficiency of the BBU pack. Moreover, current backflow might be avoided, thereby ensuring the charge reliability of the BBU pack.

In some embodiments, as shown in FIG. 1, the improved H-bridge charge unit 10 may include a first switch transistor Q5, a second switch transistor Q4, a third switch transistor Q3, a diode D1 and an inductor L1; a first end of the first switch transistor Q5 is configured to be connected to an input end PSU12VIN of a charge power source; a second end of the first switch transistor Q5 is connected to a first end of the inductor L1 and a cathode of the diode D1; a second end of the inductor L1 is connected to a first end of the second switch transistor Q4 and a second end of the third switch transistor Q3; a second end of the second switch transistor Q4 is configured to be connected to an input end PACK+ of a BBU pack; an anode of the diode D1 and a first end of the third switch transistor Q3 are grounded; control ends of the first switch transistor Q5, the second switch transistor Q4 and the third switch transistor Q3 are connected to a BBU control unit for switching charge modes of the BBU based on the control of the BBU control unit. For example, the BBU control unit might control the improved H-bridge charge unit 10 to be switched to BUCK (buck circuit) to perform pre-charge on the BBU pack, or switched to BUCK-BOOST (buck-boost circuit) to perform constant-current charge on the BBU pack, or switched to BOOST (boost circuit) to perform constant-voltage charge on the BBU pack.

Accordingly, as shown in FIG. 1, the first switch transistor Q5 may be in some embodiments a PMOS transistor, namely that, a source electrode of the first switch transistor Q5 is configured to be connected to the input end PSU12VIN of the charge power source; a drain electrode of the first switch transistor Q5 is connected to the first end of the inductor L1 and the cathode of the diode D1; a gate electrode of the first switch transistor Q5 is configured to be connected to an output end of a control signal PWM2 of the BBU control unit; the second switch transistor Q4 and the third switch transistor Q3 may be in some embodiments NMOS transistors, namely that, a source electrode of the second switch transistor Q4 might be connected to a drain electrode of the third switch transistor Q3; a drain electrode of the second switch transistor Q4 is configured to be connected to the input end of the BBU pack; a source electrode of the third switch transistor Q3 is grounded; gate electrodes of the second switch transistor Q4 and the third switch transistor Q3 are configured to be connected to respective corresponding output ends of control signals PWM3 and PWM4 of the BBU control unit; and accordingly, as shown in FIG. 1, the control ends of the first switch transistor Q5, the second switch transistor Q4 and the third switch transistor Q3 might be connected to the corresponding input ends of the control signals PWM2, PWM3 and PWM4 in the BBU control unit via respective corresponding resistors R9, R8 and R7.

In certain embodiments of the present application, as shown in FIG. 1, the BBU charge circuit in this embodiment may further include a charge input protection unit 20, configured to provide a charge input voltage sampling point and charge input current sampling points of the BBU charge circuit, and turn on or off a connection between the improved H-bridge charge unit 10 and the charge power source based on the control of a corresponding controller; where the first end of the first switch transistor Q5 is configured to be connected to the input end of the charge power source via the charge input protection unit 20. That is, the charge input protection unit 20 may turn off the connection between the improved H-bridge charge unit and the charge power source based on the control of a corresponding controller (such as a hot-plug controller or BBU control unit) when charge input voltage and charge input current are abnormal, thereby preventing charge abnormality from influencing the normal power supply of a storage system.

In certain embodiments of the present application, as shown in FIG. 1, the charge input protection unit 20 may include: a first resistor R13, a second resistor R10, a third resistor R11, and a fourth switch transistor Q1; where a first end of the first resistor R13 is connected to a first end of the second resistor R10; a common end of the first resistor R13 and the second resistor R10 is configured to be connected to the input end PSU12VIN of the charge power source; a second end of the second resistor R10 is connected to a first end of the third resistor R11; a common end of the second resistor R10 and the third resistor R11 serves as a charge input voltage sampling point VSENS; a second end of the third resistor R11 is grounded; a second end of the first resistor R13 is connected to a first end of the fourth switch transistor Q1; a second end of the fourth switch transistor Q1 is connected to a first end of the first switch transistor Q5; the first end and the second end of the first resistor R13 serve as charge input current sampling points ISENS; and a control end of the fourth switch transistor Q1 is configured to be connected to a corresponding controller. As shown in FIG. 1, the fourth switch transistor Q1 may be in some embodiments an NMOS transistor, and a control end (namely, a gate electrode) of the fourth switch transistor Q1 is connected to a corresponding input end of the control signal PWM1 in a corresponding controller via a corresponding resistor R12.

In certain embodiments of the present application, the control circuit for the BBU provided by the present application may further include: a hot-plug controller (such as a TPS247XX series hot-plug controller) connected to the control end of the fourth switch transistor Q1, where the hot-plug controller is configured to control the charge input protection unit 20 to turn on or off the connection between the improved H-bridge charge unit 10 and the charge power source by using charge input voltage and charge input current sampled at the charge input voltage sampling point VSENS and the charge input current sampling points ISENS.

In certain embodiments of the present application, as shown in FIG. 1, the BBU charge circuit may further include a charge output protection unit 30, configured to provide a charge output voltage sampling point CVSENS, charge output current sampling points CISENS and a BBU pack voltage sampling point PACKSENS of the BBU charge circuit, and turn on or off the connection between the improved H-bridge charge unit 10 and the BBU pack based on the control of a corresponding controller; where the second end of the second switch transistor Q4 is configured to be connected to the input end of the BBU pack via the charge output protection unit 30. That is, the charge output protection unit 30 may turn off the connection between the improved H-bridge charge unit and the BBU pack based on the control of a corresponding controller (such as charge output protection MCU or BBU control unit) when the charge output voltage, the charge output current or PACK status is abnormal, thereby preventing the charge abnormality from influencing the cell life of the BBU pack.

In certain embodiments of the present application, as shown in FIG. 1, the charge output protection unit 30 may include: a fourth resistor R6, a fifth resistor R5, a sixth resistor R4, a seventh resistor R2, an eighth resistor R1 and an eighth switch transistor Q2; where a first end of the fourth resistor R6 is configured to be connected to an output end of the improved H-bridge charge unit 10; a second end of the fourth resistor R6 is connected to a first end of the fifth resistor R5; a common end of the fourth resistor R6 and the fifth resistor R5 is connected to a second end of the eighth switch transistor Q2; a second end of the fifth resistor R5 is connected to a first end of the sixth resistor R4; a common end of the fifth resistor R5 and the sixth resistor R4 serves as a charge output voltage sampling point CVSENS; a first end of the eighth switch transistor Q2 is connected to a first end of the seventh resistor R2; a common end of the eighth switch transistor Q2 and the seventh resistor R2 is configured to be connected to the input end of the BBU pack; a second end of the seventh resistor R2 is connected to a first end of the eighth resistor R1; a common end of the seventh resistor R2 and the eighth resistor R1 serves as the BBU pack voltage sampling point PACKSENS; the first end and the second end of the fourth resistor R6 serve as the charge output current sampling points CISENS; and a second end of the sixth resistor R4 and a second end of the eighth resistor R1 are both grounded. As shown in FIG. 1, the eighth switch transistor R1 may be in some embodiments a PMOS transistor, and a control end (namely, a gate electrode) of the eighth switch transistor R1 is connected to a corresponding input end of the control signal PWM5 in a corresponding controller via a corresponding resistor R3.

In certain embodiments of the present application, as shown in FIG. 1, input and output ends of the improved H-bridge charge unit 10 might be connected in parallel with capacitors C3 and C1 and electrolytic capacitors C4 and C2, respectively to improve the stability of input voltage and output voltage.

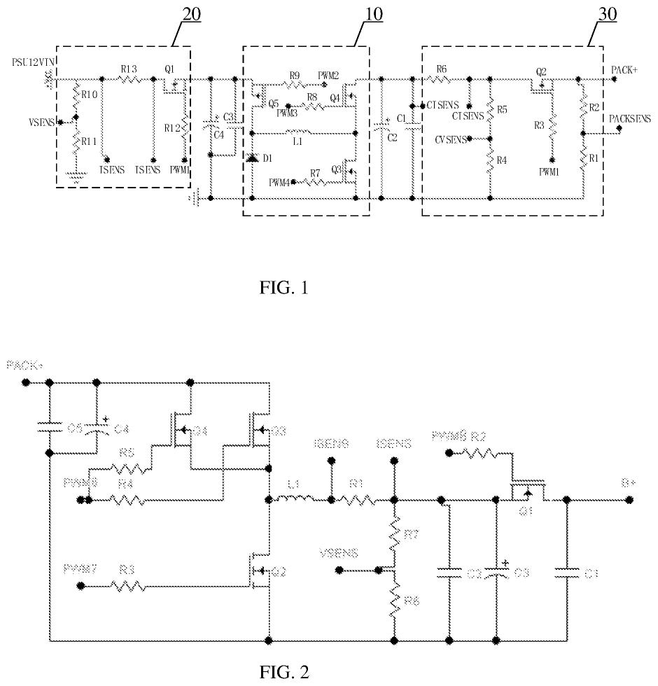

In certain embodiments of the present application, the control circuit for the BBU may further include a BBU discharge circuit, configured to supply power to a target device (such as PSU) with electric energy outputted from the BBU pack. In some embodiments, the BBU discharge circuit may include a synchronous buck unit, configured to reduce electric energy outputted from the BBU pack to preset voltage and output the same to a target device based on the control of the BBU control unit. As shown in FIG. 2, the synchronous buck unit includes a fifth switch transistor Q4, a sixth switch transistor Q3, and a seventh switch transistor Q2; where a second end of the fifth switch transistor Q4 is connected to a second end of the sixth switch transistor Q3; a common end of the fifth switch transistor Q4 and the sixth switch transistor Q3 is configured to be connected to a discharge output end PACK+ of a BBU pack; a first end of the fifth switch transistor Q4 and a first end of the sixth switch transistor Q3 are both connected to a second end of the seventh switch transistor Q2; a common end of the fifth switch transistor Q4 and the sixth switch transistor Q3 is configured to be connected to a power supply input end B+ of a target device; a first end of the seventh switch transistor Q2 is grounded; and control ends of the fifth switch transistor Q4, the sixth switch transistor Q3 and the seventh switch transistor Q2 are connected to a BBU control unit for adjusting the preset voltage based on the control of the BBU control unit. For example, the BBU control unit might adjust duty ratios of PWM signals (such as PWM6 and PWM7 in FIG. 2) corresponding to the fifth switch transistor Q4, the sixth switch transistor Q3 and the seventh switch transistor Q2 by using an all-digital PID control algorithm according to the output voltage of the BBU pack and the output voltage of the synchronous buck unit. As shown in FIG. 2, the fifth switch transistor Q4, the sixth switch transistor Q3 and the seventh switch transistor Q2 each may be in some embodiments an NMOS transistor, thereby ensuring that the output voltage of the synchronous buck unit is constant 11.5V (namely, the preset voltage), and ensuring that backup power supply cold standby and hot standby might be automatically switched. As shown in FIG. 2, the synchronous buck unit may further include a filter inductor L1, and a common end where a source electrode of the fifth switch transistor Q4, a source electrode of the sixth switch transistor Q3 and a drain electrode of the seventh switch transistor Q2 are connected might be connected to the target device via the filter inductor L1.

In certain embodiments of the present application, the BBU discharge circuit may further include an anti-backflow unit, configured to provide a discharge output voltage sampling point (such as VSENS in FIG. 2) and discharge output current sampling points (such as ISENS in FIG. 2) of the synchronous buck unit, and turn on or off a connection between the synchronous buck unit and the target device based on the control of a corresponding controller; where an output end of the synchronous buck unit is connected to the target device via the anti-backflow unit. As shown in FIG. 2, the anti-backflow unit may include: a ninth resistor R1, a tenth resistor R7, an eleventh resistor R6 and a ninth switch transistor Q1; where a first end of the ninth resistor R1 is configured to be connected to the output end of the synchronous buck unit; a second end of the ninth resistor R1 is connected to a first end of the tenth resistor R7 and a first end of the ninth switch Q1; a second end of the tenth resistor R7 is connected to a first end of the eleventh resistor R6; a common end of the tenth resistor R7 and the eleventh resistor R6 serves as the discharge output voltage sampling point VSENS; a second end of the ninth switch transistor Q1 is configured to be connected to the target device; two ends of the ninth resistor R1 serve as the discharge output current sampling points ISENS; a second end of the eleventh resistor R6 is grounded; and a control end of the ninth switch transistor Q1 is configured to be connected to a corresponding input end of the control signal PWM8 in a corresponding controller.

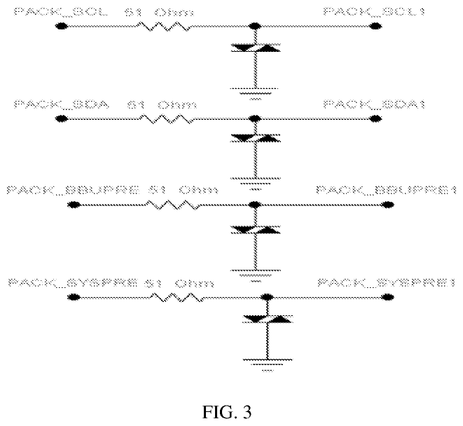

In certain embodiments of the present application, the control circuit for the BBU may further include pack-side hot-plug protection circuits arranged between connections of first target interface signals between the BBU control unit and the BBU pack, where the pack-side hot-plug protection circuit is configured to perform electrostatic protection and hot-plug protection on the first target interface signals between the BBU control unit and the BBU pack; where the first target interface signals may include at least one of a BBU in-position signal, a system in-position signal, an inter-integrated circuit (I2C) clock signal, and an I2C data signal. As shown in FIG. 3, the first target interface signals may include a BBU in-position signal PACK_BBUPRE1, a system in-position signal PACK_SYSPRE1, an I2C clock signal PACK_SCL1, and an I2C data signal PACK_SDA1.

In certain embodiments of the present application, as shown in FIG. 3, each pack-side hot-plug protection circuit may include: a first series resistor and a first bidirectional thyristor; a first end of the first series resistor is connected to a pin of a corresponding first target interface signal in the BBU control unit; a second end of the first series resistor is connected to a first end of the first bidirectional thyristor; a common end of the first series resistor and the first bidirectional thyristor is connected to a pin of a corresponding first target interface signal in the BBU pack; and a second end of the first bidirectional thyristor is grounded; that is, TVS (Transient Voltage Suppressor) protection is performed by arranging the first bidirectional thyristor in the pack-side hot-plug protection circuit, thereby preventing the hot-plug process or static electricity of the BBU pack from damaging pins corresponding to chips; and by arranging the first series resistor, damage to the printed board copper and promethium at voltage spikes is prevented.

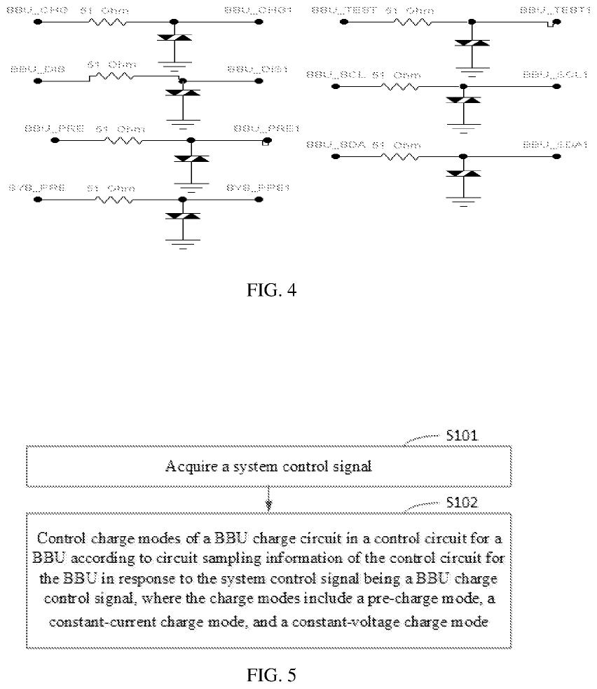

In certain embodiments of the present application, the control circuit for the BBU may further include system-side hot-plug protection circuits arranged between connections of second target interface signals between the BBU control unit and a system side; where the second target interface signals include at least one of a BBU charge enable signal, a BBU discharge enable signal, a BBU in-position signal, a system in-position signal, a BBU internal discharge enable signal, a system I2C clock signal, and a system I2C data signal. As shown in FIG. 4, the second target interface signals include a BBU charge enable signal BBU_CHG, a BBU discharge enable signal BBU_DIS, a BBU in-position signal BBU_PRE, a system in-position signal SYS_PRE, a BBU internal discharge enable signal BBU_TEST, a system I2C clock signal BBU_SCL, and a system I2C data signal BBU_SDA.

In certain embodiments of the present application, as shown in FIG. 4, each system-side hot-plug protection circuit may include: a second series resistor and a second bidirectional thyristor; a first end of the second series resistor is connected to a pin of a corresponding second target interface signal in the system side; a second end of the second series resistor is connected to a first end of the second bidirectional thyristor; a common end of the second series resistor and the second bidirectional thyristor is connected to a pin of a corresponding second target interface signal in the BBU control unit; and a second end of the second bidirectional thyristor is grounded. That is, TVS (Transient Voltage Suppressor) protection is performed by arranging the second bidirectional thyristor in the hot-plug protection circuit at the system side, thereby preventing the hot-plug process or static electricity of a BBU control board from damaging pins corresponding to chips; and by arranging the second series resistor, damage to printed board copper and promethium at voltage spikes is prevented.

In these embodiments, by arranging the improved H-bridge charge unit 10 in the BBU charge circuit, the charge circuit is combined with an anti-backflow circuit, whereby a BBU pack might be charged in multiple charge modes. Moreover, current backflow might be avoided in the charge process of the BBU pack, thereby improving the charge efficiency and reliability of the BBU pack, and thus, the BBU might provide stable and reliable power supply.

Corresponding to the above embodiments of the control circuit for the BBU, in certain embodiments of the present application, a control method for a BBU is further provided, and a control method for a BBU described below and the control circuit for the BBU described above may be cross-referenced.

Reference is now made to FIG. 5, which is a flowchart illustrating a control method for a BBU according to one or more embodiments. This method is applied to the control circuit for the BBU provided in the above-described embodiments, and may include:

step 101: acquire a system control signal.

It might be understood that the system control signal in this embodiment may be a signal transmitted from a system side (such as a storage system, server or mainframe computer) to a processor (such as a BBU control unit) for controlling charge and discharge of a BBU pack. For the specific number and types of the system control signals in this embodiment, they might be set by a designer on his/her own initiative according to practical scenarios and user requirements. For example, the system control signals may include a BBU charge control signal used for controlling charge of the BBU pack, namely that, the processor might perform charge control on the BBU pack according to an acquired BBU charge control signal; the system control signal may also include a BBU discharge control signal used for controlling discharge of the BBU pack, namely that, the processor may perform discharge control on the BBU pack according to an acquired BBU discharge control signal; the system control signal may further include a check learning signal used for controlling internal discharge of the BBU pack, namely that, the processor may control the internal discharge of the BBU pack according to an acquired BBU charge control signal so as to eliminate the error accumulation of a metering chip within the BBU pack, and the power backup capability of the BBU pack might also be further analyzed and evaluated.

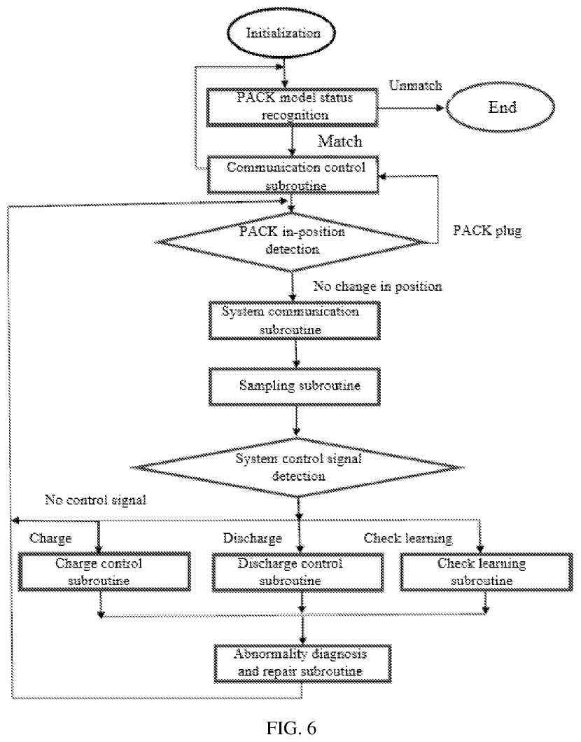

In certain embodiments of the present application, before acquiring a system control signal, a processor might also read information such as a PACK model, status and key parameters of the BBU pack when the system is powered on or the BBU pack is plugged in as detected to determine whether the PACK model of the BBU pack matches or not, whether the BBU pack is abnormal or not and the like, thereby controlling the BBU pack to operate normally when the PACK model matches and the performance is normal. As shown in FIG. 6, the processor might switch communication links according to the requirements by using a communication control subroutine when the PACK model matches, complete automatic switching of master and slave devices via SMBUS (System Management Bus) communication, and control the BBU pack to operate normally. That is, in this embodiment, before acquiring the system control signal, the processor might read the pack model of the BBU pack after the system is powered on or the BBU pack is plugged in; judge whether the pack model matches a preset pack signal or not; execute the step of acquiring a system control signal in response to the pack model matching the preset pack signal; and directly end this flow or output pack model matching abnormality information of the BBU pack in response to the pack model unmatching the preset pack signal to prompt a user to replace and adjust the BBU pack.

Further, in this embodiment, before acquiring a system control signal, the processor may also detect whether the BBU pack is in position or not to determine whether there is a plug action in the BBU pack or not, thereby controlling the BBU pack to operate normally when the BBU pack is in position. As shown in FIG. 6, the processor might scan a pack in-position signal of the BBU pack through a scanning subroutine when the PACK models match to determine whether there is a plug action in the BBU pack or not, thereby controlling the BBU pack to operate normally when the BBU pack is in-position, namely that, the BBU pack is plugged in. That is, in this embodiment, before acquiring the system control signal, the processor judges whether the BBU pack is in position or not according to the pack in-position signal of the BBU pack; execute the step of acquiring a system control signal in response to the BBU pack being in position; and directly end this flow or further scan the pack in-position signal of the BBU pack in response to the BBU pack not being in position.

In some embodiments, in this embodiment, while acquiring a system control signal, the processor may also acquire corresponding control parameter information. As shown in FIG. 6, in this step, the processor may receive a system control signal from a storage system and control parameter information (such as a charge parameter set value) via a system communication subroutine, whereby the processor might control the control circuit for the BBU by using the control parameter information and circuit sampling information to ensure the normal operation of the BBU pack.

Step 102: Control charge modes of a BBU charge circuit in a control circuit for a BBU according to circuit sampling information of the control circuit for the BBU in response to the system control signal being a BBU charge control signal; where the charge modes include a pre-charge mode, a constant-current charge mode and a constant-voltage charge mode.

It might be understood that in this embodiment, when the system control signal is a BBU charge control signal, the processor might control switching of a charge mode of the BBU charge circuit according to the circuit sampling information sampled from the control circuit for the BBU, thereby charging the BBU pack according to a switched charge mode. For example, a processor might sample and store circuit sampling information, such as BBU pack voltage, storage system supply voltage, charge input current, charge output voltage, charge output current, discharge output voltage and discharge output current by using a sampling subroutine. In this step, the processor might control switching of the charge mode of the BBU charge circuit according to a voltage difference between the BBU pack voltage and the charge output voltage among the circuit sampling information.

The method in certain embodiments of the present application may further include a process of controlling a BBU discharge circuit in the control circuit for the BBU, and supplying power to a target device (such as PSU) at preset voltage by using the discharge of the BBU pack, when the system control signal is a BBU discharge control signal. For example, in response to the system control signal being the BBU discharge control signal, the processor might adjust a PID duty ratio by using an all-digital PID control algorithm according to sampled discharge output voltage and discharge output current in the sampled BBU discharge circuit in the control circuit for the BBU, and control the output voltage of a synchronous buck unit of the BBU discharge circuit at preset voltage. As shown in FIG. 6, the processor might adjust the PID duty ratio by using a discharge control subroutine according to sampling analysis results corresponding to the discharge output voltage and the discharge output current among the circuit sampling information by the all-digital PID control algorithm, and control the output voltage of the BBU discharge circuit at the preset voltage (such as 11.5V) to ensure that the BBU pack might complete automatic switching between cold backup power supply and hot backup power supply according to the power supply requirement of the storage system.

The method in certain embodiments of the present application may further include a check learning process of controlling internal discharge of the BBU pack, eliminating error accumulation of a metering chip, and intelligently analyzing and evaluating BBU power standby capability when the system control signal is a BBU discharge control signal. For example, in response to the system control signal being a check learning signal, the processor may control the internal discharge of the BBU pack, eliminate the error accumulation of the metering chip within the BBU pack, and analyze and evaluate power standby conditions of the BBU pack.

The method in certain embodiments of the present application may further include detecting whether there is an abnormality condition or not according to acquired circuit sampling information of the control circuit for the BBU; where the abnormality condition includes at least one of pack status abnormality, charge abnormality and discharge abnormality of the BBU pack; in response to there being the abnormality condition, adjusting control parameters corresponding to abnormality results to repair the abnormality condition. That is, as shown in FIG. 6, in this embodiment, the processor might determine whether there are abnormality conditions such as pack status abnormality, charge abnormality and discharge abnormality or not according to the intelligent analysis of the circuit sampling information by using an abnormality diagnosis and repair subroutine, thereby repairing the abnormality condition according to a determined abnormality condition by adjusting corresponding charge and/or discharge control parameters. Accordingly, if the abnormality condition is not repaired within a preset time period, abnormality warning information might be outputted to prompt a user to timely handle an abnormality condition that is difficult to automatically repair. Accordingly, in this embodiment, the processor might also detect whether the system control signal has a signal abnormality condition (such as signal quality abnormality, missed or miss) or not. Thus, when detected, the signal abnormality condition is repaired, such as via communicating with the storage system.

In this embodiment of the present application, by controlling the charge mode of the BBU charge circuit in the control circuit for the BBU according to the circuit sampling information of the control circuit for the BBU, the BBU pack might be controlled to be charged in multiple charge modes, and by arranging an improved H-bridge charge unit in the BBU charge circuit, the current backflow might be avoided in the charge process of the BBU pack, thereby improving the charge efficiency and reliability of the BBU pack, whereby the BBU might provide stable and reliable power supply.

Corresponding to the above method embodiments, in certain embodiments of the present application, a control apparatus for a BBU is further provided, and a control apparatus for a BBU described below and the control method for the BBU described above may be cross-referenced.

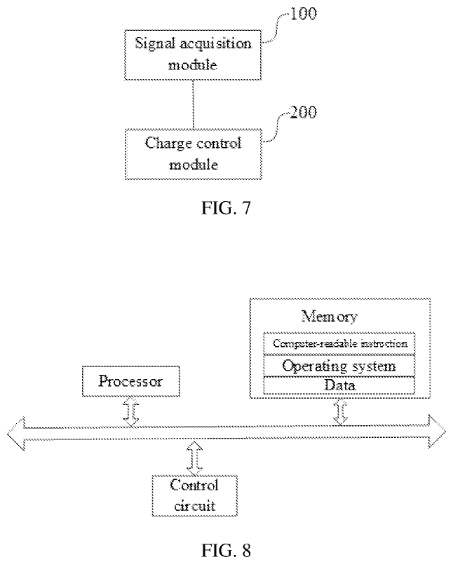

Reference is now made to FIG. 7, which is a structural block diagram of a control apparatus for a BBU according to one or more embodiments. This apparatus is applied to the control circuit for the BBU provided in the above-described embodiments, and may include:

a signal acquisition module 100, configured to acquire a system control signal; and

a charge control module 200, configured to control charge modes of a BBU charge circuit in the control circuit for the BBU according to circuit sampling information of the control circuit for the BBU in response to the system control signal being a BBU charge control signal; where the charge modes include a pre-charge mode, a constant-current charge mode and a constant-voltage charge mode.

In certain embodiments of the present application, the apparatus may further include: a model reading module (not shown in the figure) and a model judgment module (not shown in the figure); where the model reading module is configured to read a pack model of a BBU pack after a system is powered on or the BBU pack is plugged in; and the model judgment module is configured to judge whether the pack model matches a preset pack signal or not, and send a start signal to the signal acquisition module 100 in response to the pack model matching the preset pack signal.

In certain embodiments of the present application, the apparatus may further include: an in-position detection module (not shown in the figure), configured to judge whether the BBU pack is in position or not according to a pack in-position signal of the BBU pack, and send a start signal to the signal acquisition module 100 in response to the BBU pack being in position.

In certain embodiments of the present application, the apparatus may further include: a discharge control module (not shown in the figure), configured to adjust a PID duty ratio according to sampled discharge output voltage and discharge output current in a BBU discharge circuit in the control circuit for the BBU by using an all-digital PID control algorithm in response to the system control signal being the BBU discharge control signal, and control the output voltage of a synchronous buck unit of the BBU discharge circuit at preset voltage.

In certain embodiments of the present application, the apparatus may further include: an abnormality diagnosis module (not shown in the figure) and an abnormality repair module (not shown in the figure), where the abnormality diagnosis module is configured to detect whether there is an abnormality condition or not according to circuit sampling information; where the abnormality condition includes at least one of pack status abnormality, charge abnormality and discharge abnormality of the BBU pack; and the abnormality repair module is configured to adjust control parameters corresponding to abnormality results in response to there being the abnormality condition to repair the abnormality condition.

In this embodiment of the present application, by controlling, by the charge control module 200, the charge mode of the BBU charge circuit in the control circuit for the BBU according to the circuit sampling information of the control circuit for the BBU, the BBU pack might be controlled to be charged in multiple charge modes, and by arranging an improved H-bridge charge unit in the BBU charge circuit, the current backflow might be avoided in the charge process of the BBU pack, thereby improving the charge efficiency and reliability of the BBU pack, whereby the BBU might provide stable and reliable power supply.

Corresponding to the above method embodiments, in certain embodiments of the present application, a storage system is further provided, and a storage system as described below and control method for the BBU as described above might be cross-referenced.

A storage system including a memory, a processor, and the control circuit for the BBU as provided in any of the above-described embodiments; wherein,

the memory is configured to store computer-readable instructions; and

the processor is configured to implement the steps of the control method for the BBU as provided in any of the above embodiments when the computer-readable instructions are executed.

The processor in this embodiment may be a BBU control unit in the storage system. The memory in this embodiment may include one or more storage media, where the storage medium may be non-transitory. The memory may further include a high-speed random-access memory, as well as a non-volatile memory, e.g., one or more disk storage devices and flash storage devices. In this embodiment, the memory is configured to store at least the following computer-readable instructions, where the computer-readable instructions, when loaded and executed by the processor, might implement the steps of the control method for the BBU as provided in any of the embodiments described above. In addition, resources stored in the memory may further include an operating system, data and the like. and storage may be transient storage or permanent storage. The operating system may be Windows. The data may include, but is not limited to, data related to the methods described above.

Various embodiments in this description are described in a progressive manner, and each embodiment focuses on the differences from other embodiments. The same and similar parts between various embodiment might be referred to each other. For the apparatus and the storage system disclosed in the embodiments, since they correspond to the method disclosed in the embodiments, the description is relatively simple, and reference is made to the description in the method section.

The control circuit, method, and apparatus for a BBU, and a storage system provided in the present application are introduced in details above. The principles and implementations of the present application are set forth by using specific examples herein, and the descriptions of the foregoing embodiments are merely intended to help understand the method and the core idea thereof of the present application. It should be pointed out those of ordinary skilled in the art might also make several improvements and modifications to the present application without departing from the principles of the present application, and these improvements and modifications also fall within the scope of protection of the claims in the present application.

1. A control circuit for a backup battery unit (BBU), comprising a BBU charge unit,
wherein the BBU charge unit comprises an H-bridge charge unit;
the H-bridge charge unit comprises a first switch transistor, a second switch transistor, a third switch transistor, a diode, and an inductor;
a first end of the first switch transistor is configured to be connected to an input end of a charge power source, a second end of the first switch transistor is connected to a first end of the inductor and a cathode of the diode; a second end of the inductor is connected to a first end of the second switch transistor and a second end of the third switch transistor; a second end of the second switch transistor is configured to be connected to a PACK signal supplied from an input end of a BBU pack; an anode of the diode and a first end of the third switch transistor are grounded; control ends of the first switch transistor, the second switch transistor and the third switch transistor are connected to control signals of a BBU control unit for switching charge modes of the BBU based on control of the BBU control unit; and
the charge modes comprise a pre-charge mode, a constant-current charge mode, and a constant-voltage charge mode.

2. The control circuit for the BBU according to claim 1, wherein the first switch transistor, the second switch transistor, and the third switch transistor are configured to switch the H-bridge charge unit to a buck circuit when the charge mode is the pre-charge mode, switch the H-bridge charge unit to a buck-boost circuit when the charge mode is the constant-current charge mode, and switch the H-bridge charge unit to a boost circuit when the charge mode is the constant-voltage charge mode, based on the control of the BBU control unit.

3. The control circuit for the BBU according to claim 1, wherein the BBU charge unit further comprises:
a charge input protection unit, configured to provide a charge input voltage sampling point and charge input current sampling points of the BBU charge unit, and turn on or off a connection between the H-bridge charge unit and the charge power source based on control of a corresponding controller, wherein the first end of the first switch transistor is configured to be connected to the input end of the charge power source via the charge input protection unit.

4. The control circuit for the BBU according to claim 3, further comprising:
a hot-plug controller, configured to control the charge input protection unit to turn on or off the connection between the H-bridge charge unit and the charge power source by using charge input voltage and charge input current sampled at the charge input voltage sampling point and the charge input current sampling points.

5. The control circuit for the BBU according to claim 3, wherein the charge input protection unit comprises a first resistor, a second resistor, a third resistor, and a fourth switch transistor, wherein
a first end of the first resistor is connected to a first end of the second resistor; a common end of the first resistor and the second resistor is configured to be connected to the input end of the charge power source; a second end of the second resistor is connected to a first end of the third resistor; a common end of the second resistor and the third resistor serves as the charge input voltage sampling point; a second end of the third resistor is grounded; a second end of the first resistor is connected to a first end of the fourth switch transistor; a second end of the fourth switch transistor is connected to the first end of the first switch transistor; the first end and the second end of the first resistor serve as the charge input current sampling points; and a control end of the fourth switch transistor is configured to be connected to the corresponding controller.

6. The control circuit for the BBU according to claim 1, wherein the BBU charge unit further comprises:
a charge output protection unit, configured to provide a charge output voltage sampling point, charge output current sampling points and a BBU pack voltage sampling point of the BBU charge unit, and turn on or off a connection between the H-bridge charge unit and the BBU pack based on a control of a corresponding controller, wherein the second end of the second switch transistor is configured to be connected to the input end of the BBU pack via the charge output protection unit.

7. The control circuit for the BBU according to claim 1, further comprising pack-side hot-plug protection circuits arranged between connections of first target interface signals between the BBU control unit and the BBU pack, wherein the first target interface signals comprise at least one of a BBU in-position signal, a system in-position signal, an inter-integrated circuit (I2C) clock signal, or an I2C data signal; and
each of the pack-side hot-plug protection circuits comprises a first series resistor and a first bidirectional thyristor; a first end of the first series resistor is connected to a pin of a corresponding first target interface signal of the first target interface signals in the BBU control unit; a second end of the first series resistor is connected to a first end of the first bidirectional thyristor; a common end of the first series resistor and the first bidirectional thyristor is connected to a pin of a corresponding first target interface signal of the first target interface signals in the BBU pack; and a second end of the first bidirectional thyristor is grounded.

8. The control circuit for the BBU according to claim 1, further comprising system-side hot-plug protection circuits arranged between connections of second target interface signals between the BBU control unit and a system side, wherein the second target interface signals comprise at least one of a BBU charge enable signal, a BBU discharge enable signal, a BBU in-position signal, a system in-position signal, a BBU internal discharge enable signal, a system inter-integrated circuit (I2C) clock signal, or a system I2C data signal; and
each of the system-side hot-plug protection circuits comprises a second series resistor and a second bidirectional thyristor; a first end of the second series resistor is connected to a pin of a corresponding second target interface signal of the second target interface signals in the system side; a second end of the second series resistor is connected to a first end of the second bidirectional thyristor; a common end of the second series resistor and the second bidirectional thyristor is connected to a pin of a corresponding second target interface signal of the second target interface signals in the BBU control unit; and a second end of the second bidirectional thyristor is grounded.

9. The control circuit for the BBU according to claim 1, further comprising a BBU discharge circuit, wherein
the BBU discharge circuit comprises a synchronous buck unit, configured to reduce electric energy outputted from the BBU pack to a preset voltage and output the electric energy having the preset voltage to a target device based on the control of the BBU control unit.

10. The control circuit for the BBU according to claim 9, wherein the BBU discharge circuit further comprises:
an anti-backflow unit, configured to provide a discharge output voltage sampling point and discharge output current sampling points of the synchronous buck unit, and turn on or off a connection between the synchronous buck unit and the target device based on control of a corresponding controller.

11. The control circuit for the BBU according to claim 9, wherein the synchronous buck unit comprises a fifth switch transistor, a sixth switch transistor, and a seventh switch transistor, wherein a second end of the fifth switch transistor is connected to a second end of the sixth switch transistor; a common end of the fifth switch transistor and the sixth switch transistor is configured to be connected to a discharge output end of the BBU pack; a first end of the fifth switch transistor and a first end of the sixth switch transistor are both connected to a second end of the seventh switch transistor; a common end of the fifth switch transistor and the sixth switch transistor is configured to be connected to the target device; a first end of the seventh switch transistor is grounded; and control ends of the fifth switch transistor, the sixth switch transistor and the seventh switch transistor are connected to the BBU control unit for adjusting the preset voltage based on the control of the BBU control unit.

12. A control method for a backup battery unit (BBU), being applied to the control circuit for the BBU according to claim 1, and comprising:
acquiring a system control signal; and
controlling the charge modes of the BBU charge unit in the control circuit for the BBU according to circuit sampling information of the control circuit for the BBU in response to the system control signal being a BBU charge control signal, wherein the charge modes comprise the pre-charge mode, the constant-current charge mode and the constant-voltage charge mode.

13. The control method for the BBU according to claim 12, wherein before the acquiring a system control signal, the control method further comprises:
reading a pack model of the BBU pack after a system is powered on or the BBU pack is plugged in;
determining whether the pack model matches a preset pack signal or not; and
executing the step of the acquiring a system control signal in response to the pack model matching the preset pack signal.

14. The control method for the BBU according to claim 13, further comprising:
ending a flow in response to the pack model not matching the preset pack signal; or
outputting pack model matching abnormality information of the BBU pack in response to the pack model not matching the preset pack signal.

15. The control method for the BBU according to claim 12, wherein before the acquiring a system control signal, the control method further comprises:
determining whether the BBU pack is in position or not according to a pack in-position signal of the BBU pack; and
executing the step of the acquiring a system control signal in response to the BBU pack being in position.

16. The control method for the BBU according to claim 15, further comprising:
ending a flow in response to the BBU pack not being in position.

17. The control method for the BBU according to claim 12, further comprising:
adjusting a proportion-integral-derivative (PID) duty ratio according to sampled discharge output voltage and discharge output current in a BBU discharge circuit in the control circuit for the BBU by using an all-digital PID control algorithm in response to the system control signal being a BBU discharge control signal, and controlling an output voltage of a synchronous buck unit of the BBU discharge circuit at preset voltage.

18. The control method for the BBU according to claim 12, further comprising:
detecting whether there is an abnormality condition or not according to the circuit sampling information, wherein the abnormality condition comprises at least one of pack status abnormality, charge abnormality or discharge abnormality of the BBU pack; and
adjusting control parameters corresponding to the abnormality condition in response to there being the abnormality condition to repair the abnormality condition.

19. (canceled)

20. A storage system, comprising a memory, a processor, and the control circuit for the BBU according to claim 1, wherein the memory is configured to store computer-readable instructions; and
when the computer-readable instructions are executed by the processor, the processor is configured for:
acquiring a system control signal; and
controlling the charge modes of the BBU charge unit in the control circuit for the BBU according to circuit sampling information of the control circuit for the BBU in response to the system control signal being a BBU charge control signal, wherein the charge modes comprise the pre-charge mode, the constant-current charge mode and the constant-voltage charge mode.

21. A control circuit for a backup battery unit (BBU), comprising a BBU charge unit,
wherein the BBU charge unit comprises an H-bridge charge unit;
a first end of the H-bridge charge unit is configured to be connected to a PACK signal supplied from an input end of a BBU pack, second ends of the H-bridge charge unit are connected to corresponding control signals of a BBU control unit for switching charge modes of the BBU based on control of the BBU control unit; and
the charge modes comprise a pre-charge mode, a constant-current charge mode, and a constant-voltage charge mode.
